(19) United States
(12) Patent Application Publication
(10) Pub. No.: US 2026/0350234 A1
(43) Pub. Date: Nov. 5, 2026

(54) INTENT IDENTIFICATION AND PREVENTION OF WRONGFUL ARTIFICIAL INTELLIGENCE RESOURCE PROVISIONING

(71) Applicant: Kyndryl, Inc., New York, NY (US)

(72) Inventors: Mouleswara Reddy Chintakunta, Bangalore (IN); Omar Odibat, Cedar Park, TX (US); Venkat Jagana, Austin, TX (US)

(21) Appl. No.: 19/195,807

(22) Filed: May 1, 2025

(51) Int. Cl. G06F 21/71; G06F 9/46; G06F 9/50

(52) U.S. Cl. CPC G06F 21/71; G06F 9/468; G06F 9/5027

(57) ABSTRACT

Computer-implemented methods for intent identification and prevention of wrongful artificial intelligence (AI) resource provisioning. Aspects include receiving a graphics processing unit (GPU) provision request for a resource to build an AI model. Aspects include generating a provisioner responsibility observer (PRO) score and a training data analyzer (TDA) score. Aspects also include generating an intent score using the PRO score, the TDA score, and domain data associated with the GPU provision request. If the intent score is above a threshold value, aspects include granting access to and monitoring the resource as the AI model is built.

### BACKGROUND

The present invention generally relates to computer systems, and more specifically, to computer-implemented methods, computer systems, and computer program products configured and arranged for the allocation and management of computational resources during the development and training of artificial intelligence models.

In the rapidly advancing field of artificial intelligence, the allocation and management of computational resources are important for the development and training of artificial intelligence (AI) models. For example, a graphics processing unit (GPU), a specialized electronic circuit originally created for graphics engineering, has become increasingly important for the development and training of AI models. A GPU provides parallel processing capabilities, which enable performing massive computations in parallel significantly speeding up training and inference times for AI model development. GPUs also offer high memory bandwidth and capacity to handle the memory requirements of large AI models to store parameters and data. Multi-GPU computing environments provide the scalability necessary for large AI models and datasets by distributing the workload among multiple GPUs.

Existing resource monitoring systems struggle to effectively discern the intent behind computational resource requests for the development and training of AI models, particularly in distinguishing between legitimate and malicious purposes. A challenge arises from the lack of mechanisms to monitor user intent and the nature of the data used in training AI models.

Current solutions are inadequate in providing real-time intervention capabilities and fail to address the oversight of data usage, particularly in shared environments. In some instances, these systems may not be configured to detect or prevent the misuse of resources, such as their diversion toward the development of harmful AI models designed for generating malicious content or engaging in unethical activities.

### SUMMARY

Embodiments of the present invention are directed to computer-implemented methods for intent identification and prevention of wrongful artificial intelligence resource provisioning. A non-limiting computer-implemented method includes receiving a graphics processing unit (GPU) provision request for a resource to build an artificial intelligence (AI) model from a user device. The method also includes generating a provisioner responsibility observer (PRO) score using the GPU provision request. The method further includes generating a training data analyzer (TDA) score by analyzing training data associated with the GPU provision request. The method also includes generating an intent score using the PRO score, the TDA score, and domain data associated with the GPU provision request. In response to determining that the intent score is above a threshold value, the method includes granting access to the resource of the GPU provision request and monitoring the resource as the AI model is built. This can provide an improvement over known resource monitoring systems by using information from a current and previously submitted GPU provision requests to assess the intent of a user to build an AI model that is benign or malicious and providing real-time intervention capabilities to halt the development and training of an AI model upon detection of malicious activities.

In one embodiment of the present invention, generating the PRO score using the GPU provision request further includes determining that the GPU provision request is associated with an existing provisioner. The method also includes obtaining data associated with the existing provisioner. The method further includes executing an assessment check using the data associated with the existing provisioner. The method also includes generating the PRO score using the assessment check. Thus, advantageously providing an improvement by using the history of a provisioner to accurately assess the responsibility of a provisioner towards model building.

In one embodiment of the present invention, generating the PRO score using the GPU provision request further includes determining that the GPU provision request is not associated with an existing provisioner. The method further includes obtaining data associated with a similar provisioner. The method also includes executing an assessment check using the data associated with the similar provisioner. The method further includes generating the PRO score using the assessment check. Thus, advantageously providing an improvement by using the history of provisioners that are similar to a provisioner that is unknown to the computation monitoring system to accurately assess the responsibility of a provisioner towards model building.

In one embodiment of the present invention, generating the TDA score by analyzing the training data associated with the GPU provision request further includes generating a training data score by analyzing the training data of the GPU provision request using a data threat model. The method also includes generating a configuration recommendation based on the GPU provision request, the training data, and service level agreement requirements and training requirements associated with the GPU provision request. The method further includes generating a configuration score by comparing a requested configuration from the GPU provision request and the configuration recommendation. The method also includes generating the TDA score using the training data score and the configuration score. In some embodiments, the data threat model is a toxicity detection model, a personally identifiable information detection model, a derogatory speech detection model, a bias and fairness detection model, a sensitivity detection model, a content appropriateness detection model, or a security threat detection model. Thus, advantageously providing an improvement by assessing the quality of the training data to be used to build the AI model as well as the similarity between the recommended configuration and requested configuration of resources to build the AI model of the GPU provision request.

In one embodiment of the present invention, generating the intent score using the PRO score, the TDA score, and the domain data associated with the GPU provision request further includes generating a domain data score using an internet protocol (IP) address of the GPU provision request and a history of previous IP addresses associated with a provisioner of the GPU provision request. Further, the method includes generating the intent score using the domain data score, the PRO score, and the TDA score. Thus, advantageously providing an improvement by analyzing domain data associated with the GPU provision request to detect possible malicious users attempting to access the computation resources.

In one embodiment of the present invention, monitoring the resource as the AI model is built further includes validating authentication of a provisioner of the GPU provision request during execution of a task on the resource. In response to an authentication failure of the provisioner of the GPU provision request, the method further includes terminating the task on the resource of the GPU provision request and adding details of the task to a datastore. Thus, advantageously providing an improvement by continuously monitoring the computational resources while AI models are built to detect any malicious activities and halting the development of the AI models upon detection of malicious activities.

In one embodiment of the present invention, in response to determining that the intent score is below the threshold value, the method includes denying access to the resource of the GPU provision request. Thus, advantageously providing an improvement by identifying ill-intentioned users of the system and blocking their access to computational resources thereby preventing the misuse of GPU resources and ensuring that the computational power is available and allocated to legitimate and productive users of the system to develop AI models.

According to another non-limiting embodiment of the invention, a system having a memory having computer readable instructions and one or more processors for executing the computer readable instructions, the computer readable instructions controlling the one or more processors to perform operations. The operations include receiving a graphics processing unit (GPU) provision request for a resource to build an artificial intelligence (AI) model from a user device. The operations also include generating a provisioner responsibility observer (PRO) score using the GPU provision request. The operations further include generating a training data analyzer (TDA) score by analyzing training data associated with the GPU provision request. The operations also include generating an intent score using the PRO score, the TDA score, and domain data associated with the GPU provision request. In response to determining that the intent score is above a threshold value, the operations include granting access to the resource of the GPU provision request and monitoring the resource as the AI model is built. This can provide an improvement over known resource monitoring systems by using information from a current and previously submitted GPU provision requests to assess the intent of a user to build an AI model that is benign or malicious and providing real-time intervention capabilities to halt the development and training of an AI model upon detection of malicious activities.

According to another non-limiting embodiment of the invention, a computer program product is provided. The computer program product includes a computer-readable storage medium having program instructions embodied therewith, the program instructions executable by a processor to cause the processor to perform operations. The operations include receiving a graphics processing unit (GPU) provision request for a resource to build an artificial intelligence (AI) model from a user device. The operations also include generating a provisioner responsibility observer (PRO) score using the GPU provision request. The operations further include generating a training data analyzer (TDA) score by analyzing training data associated with the GPU provision request. The operations also include generating an intent score using the PRO score, the TDA score, and domain data associated with the GPU provision request. In response to determining that the intent score is above a threshold value, the operations include granting access to the resource of the GPU provision request and monitoring the resource as the AI model is built. This can provide an improvement over known resource monitoring systems by using information from a current and previously submitted GPU provision requests to assess the intent of a user to build an AI model that is benign or malicious and providing real-time intervention capabilities to halt the development and training of an AI model upon detection of malicious activities.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for intent identification and prevention of wrongful AI resource provisioning in a computing environment in accordance with one or more embodiments of the present invention;

FIG. 3 is a data flow diagram for generating a PRO score for intent identification and prevention of wrongful AI resource provisioning in a computing environment in accordance with one or more embodiments of the present invention;

FIG. 4 is a data flow diagram for generating a TDA score for intent identification and prevention of wrongful AI resource provisioning in a computing environment in accordance with one or more embodiments of the present invention;

FIG. 5 is a data flow diagram for generating an intent score for intent identification and prevention of wrongful AI resource provisioning in a computing environment in accordance with one or more embodiments of the present invention;

FIG. 6 is a data flow diagram for a multistage intent shield for intent identification and prevention of wrongful AI resource provisioning in a computing environment in accordance with one or more embodiments of the present invention;

FIG. 7 is a flowchart of a computer-implemented method for intent identification and prevention of wrongful AI resource provisioning in a computing environment in accordance with one or more embodiments of the present invention;

FIG. 8 is a flowchart of a computer-implemented method for monitoring a resource during intent identification and prevention of wrongful AI resource provisioning in a computing environment in accordance with one or more embodiments of the present invention;

FIG. 9 depicts a cloud computing environment in accordance with one or more embodiments of the present invention; and

FIG. 10 depicts abstraction model layers in accordance with one or more embodiments of the present invention.

### DETAILED DESCRIPTION

Disclosed herein are methods, systems, and computer program products for the allocation and management of computational resources during the development and training of artificial intelligence models. The development and training of AI models require access to resources of a multi-GPU computing environment. The architecture of GPUs, which include multiple cores designed for parallel processing, allows for the efficient and rapid execution of complex mathematical operations, like matrix multiplications and convolutions, required for the development and training of AI models. GPUs permit running trained models in real-time, enabling applications like image recognition, natural language processing, and autonomous driving. GPUs are equipped with high-speed memory, which is crucial for efficiently feeding the GPU cores with data, minimizing bottlenecks and speeding up AI model training and inference.

Current systems that provide resource monitoring do not assess the likely intent of a user, also known as a provisioner, requesting computational resources in a multi-GPU computing environment, which can result in the development of harmful AI models. When harmful AI models are built using the computational resources of the multi-GPU computing environment, the resources are unavailable for the development of AI models that are proposed by legitimate users of good intent.

Users of good intent typically avoid model bias and ensure equal treatment. They do not allow the AI model to perpetuate or amplify biases present in the training data and ensure that the AI model treats users fairly, regardless of the demographic characteristics of the users. Good intent actors do not use personal data without proper anonymization and consent of users, protect the privacy of users, do not violate data protection laws and regulations, and ensure compliance with legal frameworks. Good intent actors also do not deploy models that are not robust against adversarial attacks or that can produce harmful outputs. The AI models developed by good intent actors provide ongoing monitoring and maintenance of the AI model to ensure that it continues to perform safely and reliably. Good intent actors do not deploy AI models without accountability mechanisms or for unethical purposes, such as spreading misinformation, enabling surveillance without consent, or other harmful activities.

Conversely, badly intentioned or irresponsible users may enable AI models to use personal data without proper consent, anonymization, or in violation of data protection laws and may fail to implement security measures to protect user data from unauthorized access or breaches. Some users may deploy AI systems that are not adequately tested or validated or fail to continuously monitor or update the AI system to address emerging risks or performance issues. In some embodiments, the AI systems can be deployed without clear accountability structures or can be used for unethical purposes.

The systems and methods described herein are directed to a computational resource monitoring system that can assess whether the intent of a user to build an AI model is legitimate or malicious, monitor the type of data being used to train the AI model, and provide real-time capabilities to halt malicious activities during the development and training of an AI model. By identifying ill-intentioned users of the system and blocking their access to computational resources, the system can prevent the misuse of GPU resources, thereby ensuring that the computational power is available and allocated to legitimate and productive users of the system to develop AI models, thus improving overall operational efficiency, eliminating potentially negative revenue impact and productivity loss. Additionally, by identifying badly intentioned actors before the allocation of GPU resources, the system can prevent the development of harmful models, thereby reducing potential legal and reputational risks. Also, by identifying badly intentioned actors before the allocation of GPU resources, those GPU resources can be alternatively allocated and available to be utilized by good intent actors. This prevents the overburdening and overuse of GPU resources in, for example, a datacenter or cloud computing environment.

In some embodiments, the systems and methods provided herein can generate a provisioner responsibility observer (PRO) score, which is a numerical representation of the attitude of the provisioner towards building AI models. With the assistance of one or more AI techniques, the system can generate a PRO score using a GPU provision request to build an AI model received from the provisioner. Based on the information from the GPU provision request, the system can obtain a history of GPU provision requests submitted by the provisioner and generate the PRO score, which will be used to determine an intent score associated with the provisioner of the GPU provision request.

In some embodiments, the systems and methods provided herein are directed to generating a training data analysis (TDA) score. The TDA score is a numeric representation of the quality of the training data to be used to build the AI model in the GPU provision request as well as the similarity between the recommended configuration and requested configuration of resources to build the AI model of the GPU provision request, which will be used to determine an intent score associated with the provisioner of the GPU provision request

In some embodiments, the PRO score, the TDA, and other data are used to generate an intent score associated with the provisioner of the GPU provision request. The intent score is a numeric value that reflects the likely intent of the provisioner in building an AI model based on the GPU provision request, previous history of GPU provision requests, analysis of the training data set to be used to build the AI model, and other additional information. Based on the intent score, the system can block or provide access to the computational resources of the multi-GPU computing environment. Upon granting access to the computational resources, a multi-stage intent shield of the system provides continuous monitoring of the computational resources. Upon detection of any malicious activities by the provisioner, the multi-stage intent shield terminates any executing tasks associated with the development and training of the AI model of the GPU provision request and blocks any future access to the computational resources by the provisioner.

Although the systems and methods described herein are characterized in the context of monitoring GPU resources, the inventive steps can be applied to many different scenarios for monitoring computational resources.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

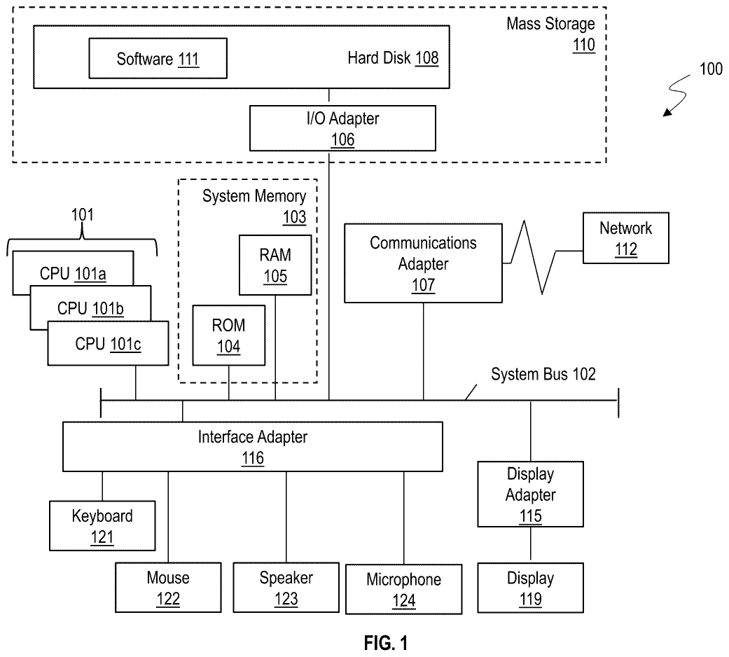

Turning now to FIG. 1, a computer system 100 is generally shown in accordance with one or more embodiments of the invention. The computer system 100 can be an electronic computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, a desktop computer, a laptop computer, a tablet computer, or a smartphone. In some examples, the computer system 100 may be a cloud computing node. The computer system 100 may be described in the general context of computer system executable instructions, such as program modules, being executed by a computer system. Generally, program modules may include routines, programs, objects, components, logic, data structures, and so on that perform tasks or implement abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, a multi-core processor, a computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

The software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

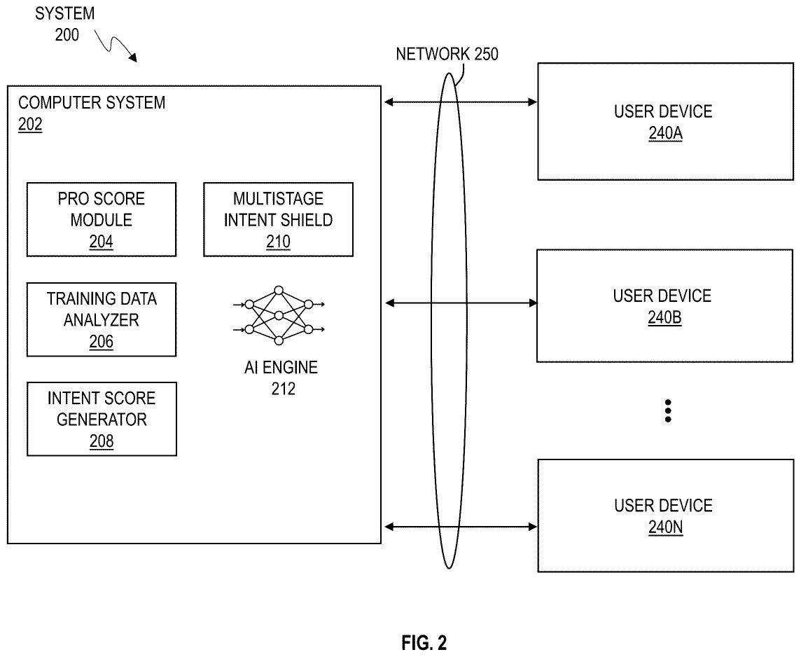

FIG. 2 depicts a block diagram of an example system 200 for intent identification and prevention of wrongful AI resource provisioning in a computing environment according to one or more embodiments. The system 200 includes a computer system 202 configured to communicate over a network 250 with many different user devices, such as a user device 240A, a user device 240B, through a user device 240N. The user devices 240A, 240B, through 240N can generally be referred to as user device 240 and are utilized to access the computing environment. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250, as understood by one of ordinary skill in the art. The computer system 202, user device(s) 240, a provisioner responsibility observer (PRO) score module 204, a training data analyzer 206, an intent score generator 208, a multistage intent shield 210, an AI engine 212, etc., can include functionality and features of the computer system 100 in FIG. 1, including various hardware components and various software applications, such as the software 111, which can be executed as instructions on one or more processors 101 in order to perform actions according to one or more embodiments of the invention. The PRO score module 204, training data analyzer 206, intent score generator 208, multistage intent shield 210, and AI engine 212 can include, be integrated with, and/or call other pieces of software, algorithms, application programming interfaces (APIs), etc., to operate as discussed herein.

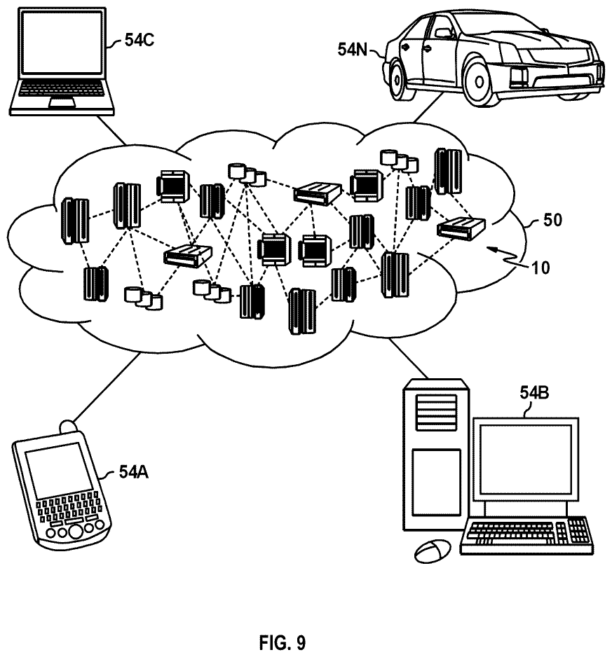

The computer system 202 may be representative of numerous computer systems and/or distributed computer systems configured for intent identification and prevention of wrongful AI resource provisioning and provide monitoring of computational resources of a multi-GPU computing environment to one or more user devices 240. The computer system 202 can be part of a cloud computing environment such as a cloud computing environment 50 depicted in FIG. 9, as discussed further herein.

In some embodiments, the computer system 202 can include one or more components for intent identification and prevention of wrongful AI resource provisioning. For example, the computer system 202 can include a PRO score module 204, a training data analyzer 206, an intent score generator 208, a multistage intent shield 210, and/or an AI engine 212.

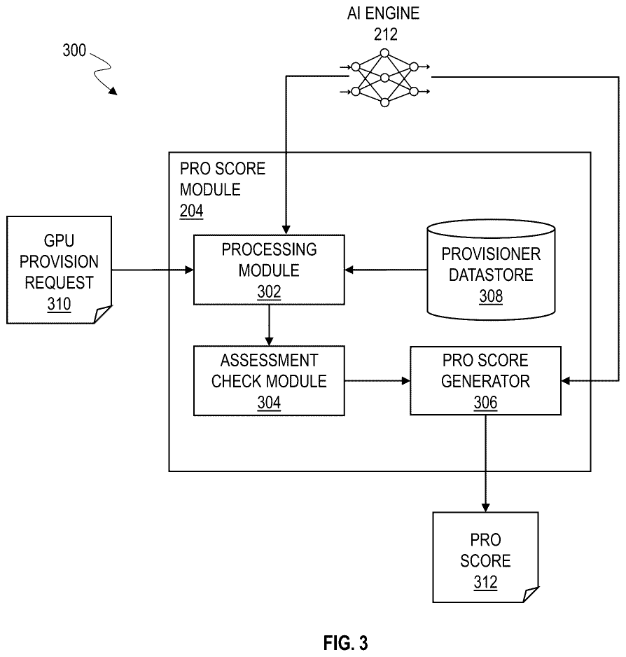

In some embodiments, the PRO score module 204 of the computer system 202 receives a graphics processing unit (GPU) provision request from a user device 240 operated by a user, also referred to as a provisioner. The GPU provision request can include a request for access to one or more resources in a computing environment, such as a multi-GPU shared environment. The PRO score module 204 receives the GPU provision request from a provisioner, analyzes the GPU provision request and data associated with the provisioner and generates a PRO score to reflect a likely level of responsibility of the provisioner towards building an AI model. The PRO score module 204 is discussed in further detail in FIG. 3.

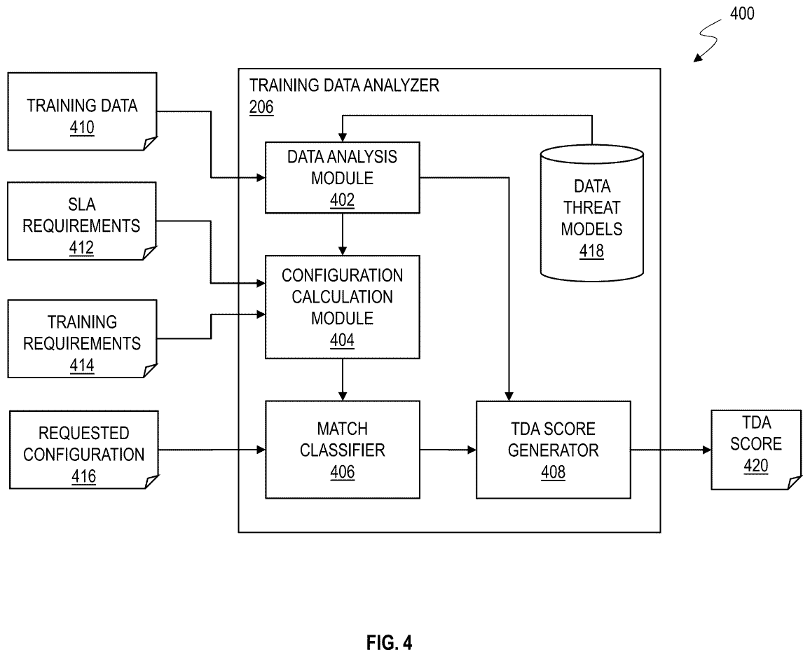

In some embodiments, the training data analyzer 206 of the computer system 202 receives or otherwise obtains the training data identified in the GPU provision request received from the provisioner. The training data analyzer 206 analyzes the training data to determine the type of data that will be used to build the AI model specified in the GPU provision request. The training data analyzer 206 can also generate a recommended configuration for the AI model being built based on the service-level agreement (SLA) associated with the GPU provision request and/or the provisioner and/or the training requirements specified in the GPU provision request. The training data analyzer 206 can use the recommended configuration, the requested configuration from the GPU provision request, and the analysis of the training data to generate a training data analysis (TDA) score that reflects the quality of the training data to be used to build the AI model as well as the similarity between the recommended configuration and requested configuration of resources to build the AI model of the GPU provision request. The training data analyzer 206 is discussed in further detail in FIG. 4.

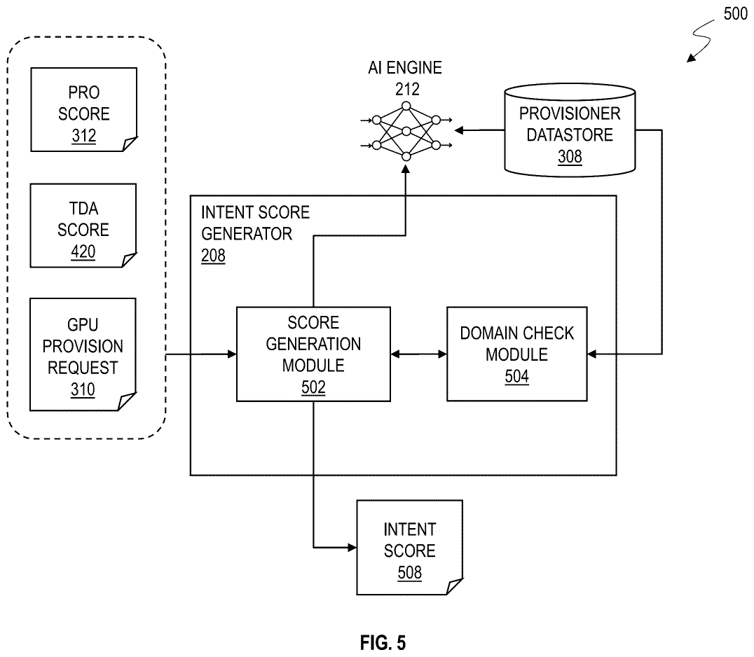

In some embodiments, the intent score generator 208 of the computer system 202 generates an intent score. The intent score is a numeric value that reflects the likely intent of the provisioner in building an AI model based on the GPU provision request, previous history of GPU provision requests, analysis of the training data set to be used to build the AI model, and other additional information. In some embodiments, the intent score generator 208 receives the PRO score from the PRO score module 204 and the TDA score from the training data analyzer 206. In some embodiments, the intent score generator 208 also analyzes domain data and uses the analysis to generate the intent score. The intent score generator 208 can compare the generated intent score to a threshold value to categorize the provisioner as a benevolent user or a malicious user. The intent score generator 208 is further discussed in FIG. 5.

In some embodiments, the multistage intent shield 210 of the computer system 202 monitors the progress of tasks using the resource of the GPU provision request and provides real-time intervention capabilities to halt the executing tasks if malicious activities are detected during the model training of the AI model of the GPU provision request. In some embodiments, the multistage intent shield 210 receives or otherwise obtains the intent score generated by the intent score generator 208 and/or the categorization of the provisioner as a benevolent or malicious user.

In one or more embodiments, the computer system 202 may include and/or be coupled to a multistage intent shield 210. Based on the intent score and/or the categorization of the provisioner as a benevolent or malicious user, the multistage intent shield 210 is configured to terminate tasks and revoke access to GPU resources in a computing environment (such as, e.g., the cloud computing environment 50 or any other computing environment having the requested GPU resources) if malicious activities are detected during the model training of the AI model identified in the GPU provision request during monitoring, thereby resulting in improved operational efficiency of the computer systems 202. The multistage intent shield 210 prevents the misuse of GPU resources by malicious users which ensures that computational power is available and allocated to legitimate and productive activities and tasks which improves the operational efficiency of the computer system 202. Additionally, by identifying malicious users before allocating GPU resources as well as terminating access to the GPU resources if malicious activities are detected, the multistage intent shield 210 prevents the development of harmful AI models.

In one or more embodiments, the computer system 202 includes one or more AI engines 212. The AI engine 212 can maintain and manage artificial intelligence models and techniques, such as deep learning models, machine learning models, neural networks, and the like. In some embodiments, the PRO score module 204, training data analyzer 206, intent score generator 208, and/or multistage intent shield 210 can communicate with the AI engine 212 to request tasks to be performed using AI. The features of the engines/classifiers maintained and managed by the AI engine 212 can be implemented by configuring and arranging the computer system 202 to execute machine learning algorithms. In some embodiments, machine learning algorithms can collect and analyze data and perform tasks without explicit instructions. Examples of engines/classifiers include but are not limited to neural networks, support vector machines (SVMs), logistic regression, decision trees, hidden Markov Models (HMMs), etc. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, neural networks, deep learning, k-nearest neighbors, Bayesian methods, and the like.

In one or more embodiments, the engines/classifiers managed by the AI engine 212 are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Now referring to FIG. 3, a data flow diagram 300 for generating a PRO score for intent identification and prevention of wrongful AI resource provisioning in a computing environment is depicted. In some embodiments, a user device 240 operated by a user, also known as a provisioner, generates and transmits a GPU provision request 310 for a resource to build an AI model. In some embodiments, the GPU provision request 310 is received by or transmitted to the processing module 302 of the PRO score module 204.

In some embodiments, the GPU provision request 310 can include different types of information. Examples of the different types of information in the GPU provision request 310 can include, but are not limited to, a user identifier associated with the provisioner, a region where the user device 240 or the provisioner is located, a requested configuration of one or more GPU resources for building an AI model, information associated with training data to be used to train the AI model built using the GPU resources, identification of one or more industries associated with the provisioner, identification of a target audience of the AI model built using the GPU resources, and the like.

In some embodiments, the processing module 302 obtains identifying information from the GPU provision request 310, such as a name, email address, user identifier, or the like and checks a datastore, such as provisioner datastore 308, that stores information about provisioners to determine if the provisioner is a greenfield user or a brownfield user. A greenfield user is a user that is unknown to the computer system 202 and has not submitted any previous GPU provision requests 310. A brownfield user is a user that is known to the computer system 202 and has a history of previously submitted GPU provision requests 310.

In response to determining that the provisioner is a brownfield user using information extracted from the GPU provision request 310, the processing module 302 retrieves data from the provisioner datastore 308 associated with the provisioner and transmits the GPU provision request 310 and the retrieved provisioner data to the assessment check module 304.

In response to determining that the provisioner is a greenfield user, the processing module 302 transmits a request or otherwise communicates with the AI engine 212 of the computer system 202. The AI engine 212 facilitates the uses of any known techniques of AI (e.g., machine learning, deep learning, neural networks, and the like) to identify one or more similar provisioners from the provisioner datastore 308 using information extracted from the GPU provision request 310. The processing module 302 transmits the GPU provision request 310 and the provisioner data of the similar provisioners identified by the AI engine 212 to the assessment check module 304.

In some embodiments, the assessment check module 304 receives the GPU provision request 310 and provisioner data (e.g., history of the provisioner of the GPU provision request 310 or data from identified similar provisioners) from the processing module 302. The assessment check module 304 performs an assessment check using data extracted from the GPU provision request 310 and the provisioner data received from the processing module 302. The assessment check module 304 uses a questionnaire to perform the assessment check. In some embodiments, the questionnaire includes questions generated with the assistance of the AI engine 212 and/or provided by an organization associated with the GPU provision request 310, such as a business, school, or the like. Examples of the questions in the questionnaire include:
“What is the workload of the training data?”
“What is the revenue impact of the AI model to be built?”
“What is the need for the AI model to be built?”
“What are the details of the target audience of the AI model to be built?”

The assessment check module 304 uses data from the GPU provision request 310 and the provisioner data to perform the assessment to determine if the current GPU provision request 310 is in line with the previous GPU provision requests 310. The assessment check module 304 also performs feature engineering on the GPU provision request 310 and the provisioner data prior to submitting them to the PRO score generator 306. Feature engineering is a preprocessing step in supervised machine learning and statistical modeling that enables the input (e.g., GPU provision request 310 and provisioner data) to be a more effective set of input for AI techniques.

The PRO score generator 306 receives the GPU provision request 310 and the provisioner data from the assessment check module 304 and generates a PRO score 312 using one or more AI techniques managed by the AI engine 212. The PRO score 312 is a numeric representation of the responsibility of the provisioner associated with the GPU provision request 310.

Now referring to FIG. 4, a data flow diagram 400 for generating a TDA score for intent identification and prevention of wrongful AI resource provisioning in a computing environment is depicted. In some embodiments, the data analysis module 402 of the training data analyzer 206 receives and/or obtains training data 410 associated with the GPU provision request 310. In some embodiments, the training data 410 is a set of data that will be utilized to train the AI model that the GPU provision request 310 is requesting to build using a resource of the GPU. The training data 410 includes examples used to fit the parameters of an AI model. In some embodiments, an AI model trains on the training data 410 using supervised learning methods. The examples and information that are included in training data 410 can be collected from many different types of sources (e.g., public, private, etc.) and may contain private or sensitive data.

The data analysis module 402 of the training data analyzer 206 analyzes the training data 410 and generates a training data score to reflect the type of data that will be used to build the AI model specified in the GPU provision request 310. In some embodiments, the data analysis module 402, in communication with the AI engine 212, uses one or more data threat models to analyze the training data 410 and generate the training data score. In some embodiments, the data threat models are retrieved from a data threat models datastore 418. The number and selection of specific data threat models can be specified by an administrator of the computer system 202 or through a request from an organization associated with the GPU provision request 310, such as a business, academic organization, or the like. Examples of data threat models can include, but are not limited to, a toxicity detection model, a personally identifiable information detection model, a derogatory speech detection model, a bias and fairness detection model, a sensitivity detection model, a content appropriateness detection model, or a security threat detection model.

In some embodiments, the data analysis module 402 generates the training data score by applying one or more data threat models to the training data 410. The training data score is a numeric representation of the quality of the training data 410. A high training data score can indicate the training data 410 is of high quality (e.g., does not contain sensitive or private data) while a low training data score can indicate that the training data 410 is low quality (e.g., does not adhere to privacy protection laws, contains bias, etc.). In some embodiments, the different data threat models can be given different scoring weights, as designated by an administrator of the computer system 202 or through a request from the organization associated with the GPU provision request 310. The data analysis module 402 generates and transmits the training data score to the TDA score generator 408.

In some embodiments, a configuration calculation module 404 of the training data analyzer 206 receives and/or obtains SLA requirements 412 and training requirements 414 associated with GPU provision request 310 and/or provisioner of the GPU provision request 310 and information about the training data 410 from the data analysis module 402. The configuration calculation module 404 generates a recommended configuration of resources of a GPU for the AI model to be built using one or more AI techniques provided by the AI engine 212.

A recommended configuration of resources of a GPU can include one or more software frameworks, GPU hardware, and/or libraries and tools of the GPU. For example, a software framework enables a user device to interact with an architecture of a GPU and distribute workloads across its cores. In some embodiments, the GPU hardware can include specialized cores which are optimized for specific tasks like matrix multiplications, which are important for AI model training. Some GPUs are equipped with high-speed memory, providing faster data transfer rates between the cores and memory for the GPU. Some GPUs are equipped with advanced memory architectures that allow for efficient handling of large and complex data structures necessary for the development and training of AI models. Examples of tools of GPUs can include high-performance deep learning inference library, integration of application frameworks like Kubernetes that allow developers to build robust pipelines for AI application development, and APIs that facilitate the integration of GPU resources into AI workflows. A recommended configuration of resources of a GPU can include a different combination of software frameworks, GPU hardware, and/or libraries and tools of the GPU.

In some embodiments, a match classifier of the training data analyzer 206 receives the recommended configuration from the configuration calculation module 404 and obtains the requested configuration for resources of GPUs from the GPU provision request 310. The match classifier 406 compares the requested configuration of the GPU provision request 310 with the recommended configuration generated by the configuration calculation module 404 and generates a configuration score that reflects whether the requested configuration is an approximate match with the recommended configuration, an overprovisioned request, or an under-provisioned request. An overprovisioned request from the GPU provision request 310 (e.g., requesting more resources than the recommended configuration for computational resources) can indicate that the provisioner is requesting more resources than necessary for the development and training of an AI model and the additional resources may be used for malicious activities or for unapproved features in the AI model. An under provisioned request from the GPU provision request 310 (e.g., requesting less resources than the recommended configuration for computational resources) can indicate that the provisioner has not fully disclosed all the features of the AI model of the GPU provision request 310, which may include additional features that are unapproved or unauthorized. The match classifier 406 transmits the configuration score to the TDA score generator 408 of the training data analyzer 206.

In some embodiments, the TDA score generator 408 receives the training data score from the data analysis module 402 and the configuration score of the requested configuration from the match classifier 406 and generates a TDA score 420 that reflects the quality of the training data 410 to be used to build the AI model as well as the similarity between the recommended configuration and requested configuration of resources to build the AI model of the GPU provision request 310. In some embodiments, a higher value for the TDA score indicates that the training data 410 is high quality (e.g., does not contain bias or derogatory speech, does not include data that violates privacy protections, does not include data that contains personally identifiable information, etc.) and that the requested configuration from the GPU provision request 310 and the recommended configuration generated by the configuration calculation module 404 are similarly matched in computational resources of a multi-GPU computing environment.

Now referring to FIG. 5, a data flow diagram 500 for generating an intent score for intent identification and prevention of wrongful AI resource provisioning in a computing environment is depicted. The score generation module 502 of the intent score generator 208 receives the PRO score 312, the TDA score 420, and the GPU provision request 310. In some embodiments, if the score generation module 502 determines that provisioner associated with the GPU provision request 310 is a greenfield user, the score generation module 502 communicates with the AI engine 212 to use one or more AI techniques to identify similar provisioners from the provisioner datastore 308 using data from the GPU provision request 310.

The score generation module 502 extracts an IP address from the GPU provision request 310 and identifying information of the provisioner and transmits it to the domain check module 504. The domain check module 504 uses the provisioner data of the GPU provision request 310 and checks the provisioner datastore 308 to determine if the IP address of the GPU provision request 310 is the same as any previously submitted GPU provision requests 310 or if it originates from a region associated with the provisioner. The domain check module 504 generates a domain data score based on the IP address of the GPU provision request 310 and the history of previous IP addresses associated with the GPU provision request 310. In some embodiments, the domain check module 504 communicates with the AI engine 212 to use one or more AI techniques to generate the domain data score. The domain data score is a numeric value that reflects a match or mismatch of the IP address of the GPU provision request 310 compared to the history of previous IP addresses. In some embodiments, a higher value domain data score indicates that the IP address is a match or close in regional proximity to previous GPU provision request 310 IP addresses while a lower value domain data score indicates a likely mismatch of the IP address and the history of previous IP addresses. The lower value domain data score may indicate a malicious user attempting to gain access to the computer system 202 by disguising their request as originating from a known provisioner.

The domain check module 504 transmits the domain data score to the score generation module 502. The score generation module 502 communicates with the AI engine 212 to use one or more AI techniques to generate an intent score 508 associated with the GPU provision request using the PRO score 312, the TDA score, and the domain data score. In some embodiments, if the score generation module 502 requested the identification of similar provisioners from the provisioner datastore 308, the intent scores 508 associated with the identified provisioners are also used to generate the intent score 508 for the GPU provision request. In some embodiments, the AI technique used to generate the intent score 508 processes the inputs received from the computer system 202 (e.g., PRO score 312, TDA score, domain data, etc.) in numerical form called embeddings and can use a neural network regression model to generate the intent score 508. In some embodiments, the intent score 508 is generated by the score generation module 502 as a numerical value between 0-100.

In some embodiments, a high intent score 508 indicates that the provisioner is a legitimate user and is classified as a benevolent user of the computer system 202 and is granted access to the requested computational resource of the GPU, while a low intent score 508 indicates that the provisioner may be a malicious user and is classified as a malicious user of the computer system 202 and is denied access to the requested computational resource of the GPU. The score generation module 502 transmits the intent score 508 to the multistage intent shield 210.

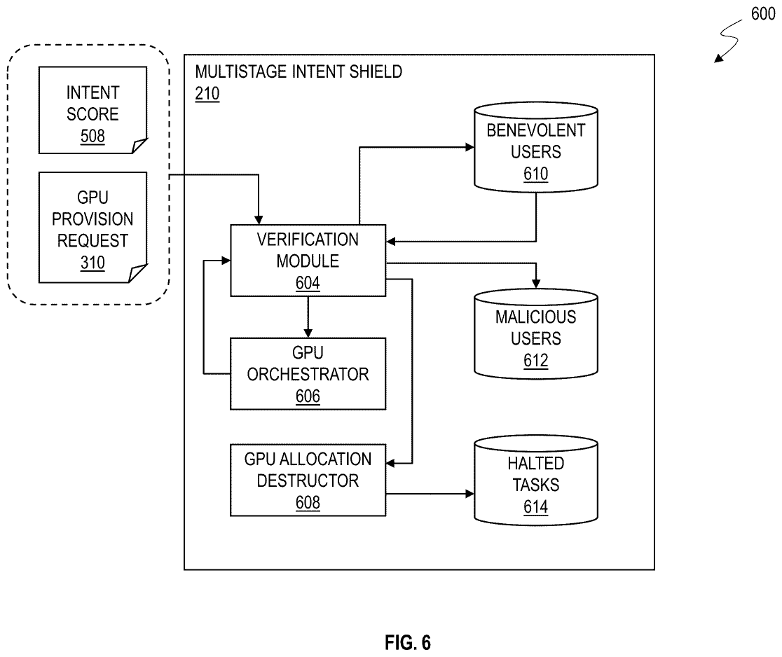

Now referring to FIG. 6, a data flow diagram 600 for a multistage intent shield for intent identification and prevention of wrongful AI resource provisioning in a computing environment is depicted. In some embodiments, the multistage intent shield 210 receives the GPU provision request 310 and the intent score 508. The verification module 604 of the multistage intent shield 210 compares the intent score 508 with a threshold value. In some embodiments, the threshold value is a predetermined value. In some embodiments, the threshold value is configurable by an administrator of the computer system 202.

The verification module 604 extracts identifying information about the provisioner from the GPU provision request 310 and checks the benevolent users datastore 610. The benevolent users datastore 610 stores data associated with provisioners that have previously used the computer system 202 and do not have a history or any indication of malicious activities.

The verification module 604 checks the benevolent users datastore 610 to see if the provisioner associated with the GPU provision request 310 is a known benevolent user. If the provisioner is not included in the benevolent users datastore 610, the verification module 604 generates a shield identifier for the provisioner using one or more known techniques for generating unique identifiers and uses a combination of data from the GPU provision request 310. The shield identifier is a unique identifier associated with a provisioner and used throughout the monitoring process of the resources of the GPU to detect any malicious activities. In some embodiments, the verification module 604 attaches the shield identifier to the GPU provision request 310.

The verification module 604 stores the shield identifier along with additional data associated with the provisioner in the benevolent users datastore 610. Examples of the data associated with the provisioner stored in the benevolent users datastore 610 can include, but is not limited to, any other known identifiers associated with the provisioner, the intent score 508, the data type of the training data 410, the requested configuration of resources from the GPU provision request 310, the region associated with provisioner and/or the GPU provision request 310, and the like.

In some embodiments, the verification module 604 processes the GPU provision request 310 to determine if the provisioner credentials associated with it are valid. For example, the verification module 604 processes the GPU provision request 310 to identify any shield identifiers attached to the GPU provision request 310. If the GPU provision request 310 does not have an attached shield identifier or has multiple attached shield identifiers, the verification module 604 determines that the provisioner credentials are not valid.

In some embodiments, the verification module 604 identifies a shield identifier attached to the GPU provision request 310 and uses the shield identifier to check a malicious users datastore 612. The malicious users datastore 612 stores information about provisioners classified as malicious users based on previous GPU provision requests 310 or identified malicious activities. If the shield identifier attached to the GPU provision request 310 is found in the malicious users datastore 612, the verification module 604 determines that the provisioner credentials of the GPU provision request 310 are not valid.

In response to determining that the provisioner credentials of the GPU provision request 310 are not valid, the verification module 604 blocks the IP address associated with the GPU provision request and adds the data associated with the provisioner to the malicious users datastore 612. The verification module 604 also removes any data associated with the provisioner from the benevolent users datastore 610. Examples of the data stored in the malicious users datastore 612 include an IP address, a region associated with the provisioner and/or the GPU provision request 310, the authentication credentials of the provisioner, data associated with attempts to access the computer system 202, any invalid shield identifiers used in an attempt to access the computer system 202, and the like. In some embodiments, the benevolent users datastore 610 and the malicious users datastore are associated with and/or are components of the provisioner datastore 308.

In response to determining that the provisioner credentials of the GPU provision request 310 are valid, the verification module 604 grants access to the provisioner to the resources (e.g., in the cloud computing environment 50) requested in the GPU provision request 310. The GPU orchestrator 606 receives an indication from the verification module 604 that access has been granted to the provisioner. The GPU orchestrator 606 allocates resources for tasks based on the GPU provision request 310 and monitors the tasks and the GPU resources as the AI model of the GPU provision request 310 is built.

In some embodiments, the GPU orchestrator 606 monitors the progress of the tasks executing on the resources of the GPU and frequently validates the authentication of the provisioner associated with the executing tasks. For example, the GPU orchestrator 606 communicates with the verification module 604 at periodic intervals of time (e.g., every 30 minutes) to validate the authentication of the provisioner associated with an executing task. The periodic intervals of time can be predetermined or are configurable by an administrator of the system. In some embodiments, the GPU orchestrator 606 communicates with the verification module 604 to validate the authentication of the provisioner associated with an executing task at specified increments of progress of the task (e.g., every 10% increment).

The verification module 604 retrieves an authentication history from the benevolent users datastore 610 using the shield identifier associated with the executing task. The verification module 604 determines that there is an authentication failure of the provisioner based on the authentication history. For example, the verification module 604 determines that there is an authentication failure if there are too many failed attempts to access the computer system 202, if the provisioner attempted to access the system from a blocked IP address, or the like.

If the verification module 604 successfully validates the authentication of the provisioner of the executing task, the GPU orchestrator continues to monitor its progress until the task completes. If there is an authentication failure of the provisioner of the executing task, the verification module 604 updates the benevolent users datastore 610 and malicious users datastore 612 accordingly and communicates the authentication failure to the GPU allocation destructor 608. The GPU allocation destructor 608 terminates the task executing on the resource of the GPU and add details of the task and associated provisioner details to a halted tasks datastore 614. In some embodiments, the halted tasks datastore 614 is associated with the malicious users datastore 612 and/or the provisioner datastore 308 and can be used to generate intent scores 508 for newly received GPU provision requests 310.

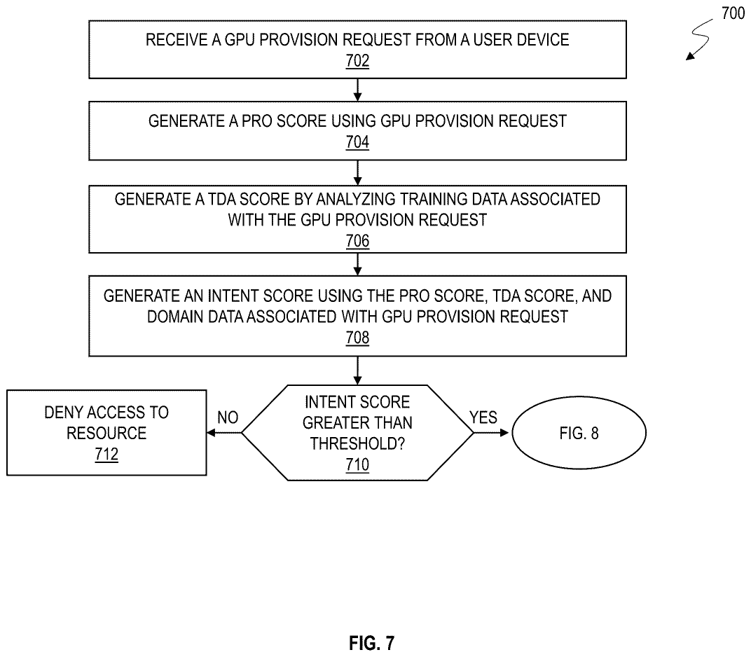

Now referring to FIG. 7, a flowchart depicts a computer-implemented method 700 for intent identification and prevention of wrongful AI resource provisioning in a computing environment. The computer-implemented method 700 is executed by the computer system 202. Reference can be made to any figures discussed herein.

At block 702 of the computer-implemented method 700, a user device 240 operated by a provisioner transmits a GPU provision request 310 to the computer system 202. The GPU provision request 310 contains a request for a resource of the GPU to build an AI model as well as additional information, such as information about the provisioner, a requested configuration of the resource of the GPU, a target audience for the AI model, an industry associated with the provisioner and/or AI model, and the like.

Next at block 704, a PRO score 312 is generated using the GPU provision request 310. In some embodiments, the PRO score module 204 receives the GPU provision request 310. The processing module 302 of the PRO score module 204 determines whether the provisioner associated with the GPU provision request 310 is a greenfield user or brownfield user to the computer system 202. If the provisioner is a greenfield user, the processing module 302 directs the AI engine 212 to use one or more AI techniques to identify one or more similar provisioners from the provisioner datastore 308 using information from the GPU provision request 310. If the provisioner is a brownfield user, the processing module 302 retrieves information from the provisioner datastore 308 associated with the provisioner of the GPU provision request 310.

The processing module 302 of the PRO score module 204 transmits the provisioner data (i.e., history of the provisioner of the GPU provision request 310 or data from identified similar provisioners) to the assessment check module 304. The assessment check module 304 performs an assessment check on the data received from the PRO score module 204 to evaluate the quality and suitability of the received data. In some embodiments, based on the results of the assessment check, the assessment check module 304 facilitates feature engineering of the received data. The assessment check module 304 communicates with the AI engine 212 to direct one or more machine learning models to generate the PRO score 312 using the optimized data from the feature engineering.

Next at block 706, a TDA score 420 is generated by analyzing the training data 410 associated with the GPU provision request 310. The training data analyzer 206 obtains the training data 410 identified in the GPU provision request 310. The training data analyzer 206, in communication with the AI engine 212, analyzes the training data 410 using one or more data threat models and generates a training data score to reflect the type and quality of data that will be used to build the AI model specified in the GPU provision request 310. The number and type of data threat model to be used during the analysis of the training data 410 and the generation of the training data score can be specified by an administrator of the computer system 202 or through a request from a person or organization associated with the GPU provision request 310. In some embodiments, the administrator or the person or organization associated with the GPU provision request 310 can also specify scoring weights to associate with each of the data threat models used during the generation of the training data score.

In some embodiments, the configuration calculation module 404 of the training data analyzer 206 generates a recommended configuration for the AI model from the GPU provision request 310 based on the SLA requirements 412 associated with the GPU provision request 310 and/or the provisioner and the training requirements 414 specified in the GPU provision request 310. A match classifier 406 of the training data analyzer 206 compares the requested configuration of the GPU provision request 310 with the recommended configuration generated by the configuration calculation module 404 to generate a configuration score that reflects whether the configurations are an approximate match, the requested configuration is an overprovisioned request, or the requested configuration is an under-provisioned request. The match classifier 406 transmits the configuration score to the TDA score generator 408 of the training data analyzer 206. The TDA score generator 408, in communication with the AI engine 212, generates the TDA score 420 using one or more AI techniques that use the training data score received from the data analysis module 402 and the configuration score received from the match classifier 406.

Next at block 708, an intent score 508 is generated using the PRO score 312, the TDA score 420, and domain data associated with the GPU provision request 310. In some embodiments, the score generation module 502 of the intent score generator 208 receives the PRO score 312 from the PRO score module 204, the TDA score 420 from the training data analyzer 206, and the GPU provision request 310. The score generation module 502 transmits data from the GPU provision request 310 to the domain check module 504 of the intent score generator 208. The domain check module 504 uses the data from the GPU provision request 310 to compare the IP address of the GPU provision request 310 to a history of previous IP addresses associated with the provisioner of the GPU provision request 310. The domain check module 504 generates a domain data score using the IP address of the GPU provision request 310 and the history of previous IP addresses associated with a provisioner of the GPU provision request 310. The score generation module 502 communicates with the AI engine 212 to generate the intent score 508 using one or more AI techniques and based on the domain data score, the PRO score 312, and the TDA score 420.

Next at block 710, a determination is made whether the intent score 508 is greater than a threshold value. In some embodiments, the threshold value is a pre-set value. In some embodiments, the threshold value is a value configurable by an administrator of the computer system 202. The multistage intent shield 210 receives the intent score 508 and compares it to the threshold value. If the intent score 508 is less than the threshold value, the multistage intent shield 210 categorizes the provisioner as a malicious user and the method 700 proceeds to block 712. At block 712, the multistage intent shield 210 denies access for the provisioner to the resource requested in the GPU provision request 310 and adds the data associated with the provisioner to a malicious users datastore 612.

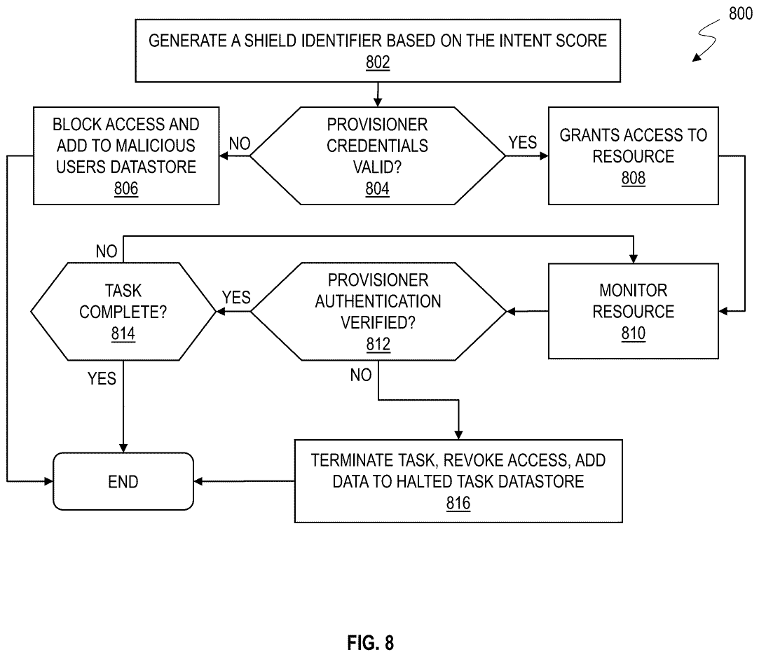

If the intent score 508 is greater than or equal to the threshold value, the multistage intent shield 210 categorizes the provisioner as a benevolent user and the method 700 proceeds to FIG. 8, where the multistage intent shield 210 grants access to the provisioner for resources of the GPU, monitors the progress of the tasks executing on the resources of the GPU, and provides real-time intervention capabilities to terminate tasks upon detection of malicious activities.

Now referring to FIG. 8, a flowchart depicts a computer-implemented method 800 for monitoring a resource during intent identification and prevention of wrongful AI resource provisioning in a computing environment. The computer-implemented method 800 is executed by the computer system 202. Reference can be made to any figures discussed herein.

At block 802 of the computer-implemented method 800, a shield identifier is generated based on the intent score 508. In some embodiments, the verification module 604 of the multistage intent shield 210 receives the GPU provision request 310 and the intent score 508. The verification module 604 checks the benevolent users datastore 610 for inclusion of data associated with the provisioner. If the verification module 604 determines that the provisioner is not part of the benevolent users datastore 610, the verification module 604 generates a shield identifier for the provisioner using one or more known techniques for generating unique identifiers and uses a combination of data from the GPU provision request 310. The verification module 604 stores the shield identifier along with additional data associated with the provisioner in the benevolent users datastore 610. Examples of the data associated with the provisioner stored in the benevolent users datastore 610 can include, but is not limited to, any other known identifiers associated with the provisioner, the intent score 508, the data type of the training data 410, the requested configuration of resources from the GPU provision request 310, the region associated with provisioner and/or the GPU provision request 310, and the like.

Next at block 804, provisioner credentials are checked to determine if they are valid. In some embodiments, the verification module 604 of the multistage intent shield 210 checks the provisioner credentials to determine if they are valid. In some examples, the verification module 604 checks the provisioner credentials by processing the GPU provision request 310 to identify any shield identifiers attached to the request. If the GPU provision request 310 does not have a shield identifier attached or has an invalid shield identifier attached to the GPU provision request 310, the verification module 604 determines that the provisioner credentials are not valid. In some embodiments, the verification module 604 identifies a valid shield identifier attached to the GPU provision request 310 and uses the shield identifier to check the malicious users datastore 612. If the verification module 604 determines the shield identifier is in the malicious users datastore 612, the verification module 604 determines that the provisioner credentials are not valid.

In response to determining that the provisioner credentials are not valid, the method 800 proceeds to block 806. At block 806, the verification module 604 blocks access for the provisioner to the resource of the GPU and adds the details of the provisioner to the malicious users datastore 612. The method 800 then ends.

At block 804, if the verification module 604 determines that the provisioner credentials are valid, the method 800 proceeds to block 808. At block 808, the GPU orchestrator 606 of the multistage intent shield 210 grants access for the provisioner to the resource of the GPU. At block 810, the GPU orchestrator 606 monitors the status of the GPU as tasks associated with the GPU provision request 310 execute. The GPU orchestrator 606 frequently checks the executing tasks and their associated provisioner details. In some embodiments, the GPU orchestrator 606 will closely monitor tasks whose execution progress is greater than a predetermined value (e.g., greater than 90% complete).

Next at block 812, the GPU orchestrator 606 communicates with the verification module 604 to verify authentication of the provisioner associated with executing tasks. In some embodiments, the verification module 604 retrieves the authentication history of the provisioner from the benevolent users datastore 610 using the shield identifier associated with the executing task. If the verification module 604 does not detect any unusual activity in the authentication history of the provisioner, the verification module 604 determines that the provisioner authentication is valid. If the verification module 604 identifies unusual activity from the authentication history (e.g., multiple failed attempts to access the computer system 202, IP address associated with a known malicious user, or the like), the verification module determines that there is a provisioner authentication failure.

If the verification module 604 successfully verifies the provisioner authentication associated with an executing task, the method 800 proceeds to block 814. If the verification module 604 determines that there is a provisioner authentication failure associated with an executing task, the verification module 604 uses the shield identifier to remove the provisioner from the benevolent users datastore 610 and adds the data to the malicious users datastore 612. The method 800 then proceeds to block 816.

At block 814, the GPU orchestrator 606 checks the status of the task executing on the resource of the GPU. If the GPU orchestrator 606 determines that the task is complete, the method 800 ends. If the GPU orchestrator 606 determines that the task is not complete, the method 800 proceeds back to block 810, where the GPU orchestrator 606 continues to monitor its progress and the resource of the GPU.

At block 816, the verification module 604 communicates to the GPU allocation destructor 608 of the provisioner authentication failure associated with the executing task. The GPU allocation destructor 608 revokes access of the provisioner to the resource and terminates the executing task. The GPU allocation destructor 608 collects information associated with the task, such as the shield identifier associated with the task, provisioner data associated with the task, task description, identification of the resources consumed by the task, and the like, and transmits the information to a halted tasks datastore 614. In some embodiments, the halted tasks datastore 614 is used to generate intent scores for incoming GPU provision requests 310 or other functions for intent identification and prevention of wrongful AI resource provisioning.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

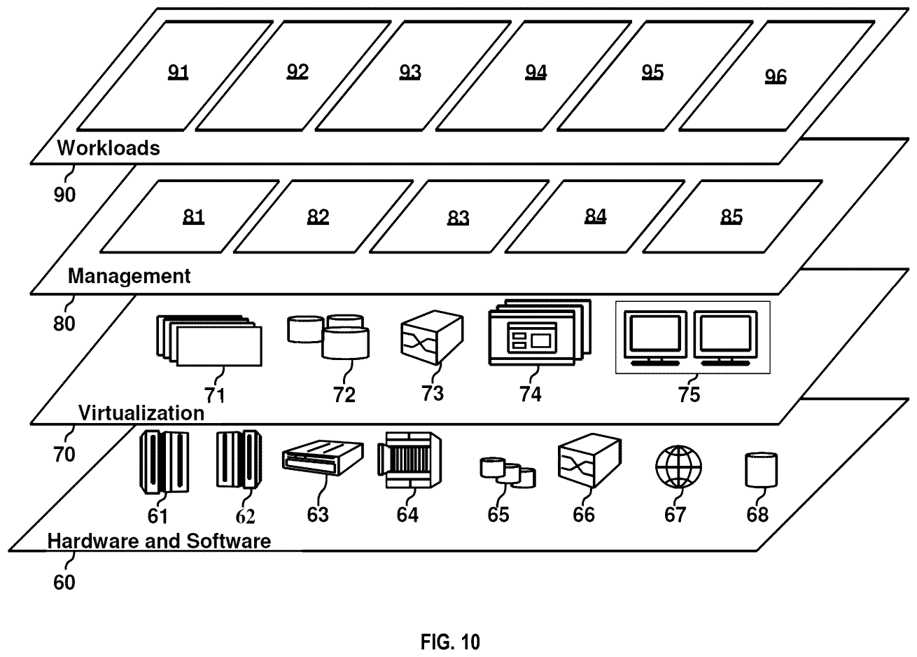

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Examples of workloads and functions 96 includes intent identification and prevention of wrongful AI resource provisioning by generating an intent score indicative of the likely intent of a provisioner requesting GPU resources to build an AI model. The workloads and functions 96 generates the intent score using data from a request for a GPU resource to build AI models and additional related information using one or more AI techniques. The workloads and functions 96 can also provide continuous monitoring of tasks executing on one or more GPU resources as one or more AI models are built and provide real-time intervention capabilities to terminate tasks if malicious activities are detected during execution of the tasks.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a graphics processing unit (GPU) provision request for a resource to build an artificial intelligence (AI) model from a user device;
generating a provisioner responsibility observer (PRO) score using the GPU provision request;
generating a training data analyzer (TDA) score by analyzing training data associated with the GPU provision request;
generating an intent score using the PRO score, the TDA score, and domain data associated with the GPU provision request; and
in response to determining that the intent score is above a threshold value, granting access to the resource of the GPU provision request and monitoring the resource as the AI model is built.

2. The computer-implemented method of claim 1, wherein generating the PRO score using the GPU provision request further comprises:
determining that the GPU provision request is associated with an existing provisioner;
obtaining data associated with the existing provisioner;
executing an assessment check using the data associated with the existing provisioner; and
generating the PRO score using the assessment check.

3. The computer-implemented method of claim 1, wherein generating the PRO score using the GPU provision request further comprises:
determining that the GPU provision request is not associated with an existing provisioner;
obtaining data associated with a similar provisioner;
executing an assessment check using the data associated with the similar provisioner; and
generating the PRO score using the assessment check.

4. The computer-implemented method of claim 1, wherein generating the TDA score by analyzing the training data associated with the GPU provision request further comprises:
generating a training data score by analyzing the training data of the GPU provision request using a data threat model;
generating a configuration recommendation based on the GPU provision request, the training data, and service level agreement requirements and training requirements associated with the GPU provision request;
generating a configuration score by comparing a requested configuration from the GPU provision request and the configuration recommendation; and
generating the TDA score using the training data score and the configuration score.

5. The computer-implemented method of claim 4, wherein the data threat model is a toxicity detection model, a personally identifiable information detection model, a derogatory speech detection model, a bias and fairness detection model, a sensitivity detection model, a content appropriateness detection model, or a security threat detection model.

6. The computer-implemented method of claim 1, wherein generating the intent score using the PRO score, the TDA score, and the domain data associated with the GPU provision request further comprises:
generating a domain data score using an internet protocol (IP) address of the GPU provision request and a history of previous IP addresses associated with a provisioner of the GPU provision request; and
generating the intent score using the domain data score, the PRO score, and the TDA score.

7. The computer-implemented method of claim 1, wherein monitoring the resource as the AI model is built further comprises:
validating authentication of a provisioner of the GPU provision request during execution of a task on the resource; and
in response to an authentication failure of the provisioner of the GPU provision request, terminating the task on the resource of the GPU provision request and adding details of the task to a datastore.

8. The computer-implemented method of claim 1, further comprising, in response to determining that the intent score is below the threshold value, denying access to the resource of the GPU provision request.

9. A system comprising:
a memory having computer-readable instructions; and
one or more processors for executing the computer readable instructions, the computer readable instructions controlling the one or more processors to perform operations comprising:
receiving a graphics processing unit (GPU) provision request for a resource to build an artificial intelligence (AI) model from a user device;
generating a provisioner responsibility observer (PRO) score using the GPU provision request;
generating a training data analyzer (TDA) score by analyzing training data associated with the GPU provision request;
generating an intent score using the PRO score, the TDA score, and domain data associated with the GPU provision request; and
in response to determining that the intent score is above a threshold value, granting access to the resource of the GPU provision request and monitoring the resource as the AI model is built.

10. The system of claim 9, wherein the operations to generate the PRO score using the GPU provision request further comprise:
determining that the GPU provision request is associated with an existing provisioner;
obtaining data associated with the existing provisioner;
executing an assessment check using the data associated with the existing provisioner; and
generating the PRO score using the assessment check.

11. The system of claim 9, wherein the operations to generate the PRO score using the GPU provision request further comprise:
determining that the GPU provision request is not associated with an existing provisioner;
obtaining data associated with a similar provisioner;
executing an assessment check using the data associated with the similar provisioner; and
generating the PRO score using the assessment check.

12. The system of claim 9, wherein the operations to generate the TDA score by analyzing the training data associated with the GPU provision request further comprise:
generating a training data score by analyzing the training data of the GPU provision request using a data threat model;
generating a configuration recommendation based on the GPU provision request, the training data, and service level agreement requirements and training requirements associated with the GPU provision request;
generating a configuration score by comparing a requested configuration from the GPU provision request and the configuration recommendation; and
generating the TDA score using the training data score and the configuration score.

13. The system of claim 12, wherein the data threat model is a toxicity detection model, a personally identifiable information detection model, a derogatory speech detection model, a bias and fairness detection model, a sensitivity detection model, a content appropriateness detection model, or a security threat detection model.

14. The system of claim 9, wherein the operations to generate the intent score using the PRO score, the TDA score, and the domain data associated with the GPU provision request further comprise:
generating a domain data score using an internet protocol (IP) address of the GPU provision request and a history of previous IP addresses associated with a provisioner of the GPU provision request; and
generating the intent score using the domain data score, the PRO score, and the TDA score.

15. The system of claim 9, wherein the operations to monitor the resource as the AI model is built further comprise:
validating authentication of a provisioner of the GPU provision request during execution of a task on the resource; and
in response to an authentication failure of the provisioner of the GPU provision request, terminating the task on the resource of the GPU provision request and adding details of the task to a datastore.

16. The system of claim 9, wherein the operations further comprise, in response to determining that the intent score is below the threshold value, denying access to the resource of the GPU provision request.

17. A computer program product comprising a computer readable storage medium having program instructions embodied therewith, the program instructions executable by one or more processors to cause the one or more processors to perform operations comprising:
receiving a graphics processing unit (GPU) provision request for a resource to build an artificial intelligence (AI) model from a user device;
generating a provisioner responsibility observer (PRO) score using the GPU provision request;
generating a training data analyzer (TDA) score by analyzing training data associated with the GPU provision request;
generating an intent score using the PRO score, the TDA score, and domain data associated with the GPU provision request; and
in response to determining that the intent score is above a threshold value, granting access to the resource of the GPU provision request and monitoring the resource as the AI model is built.

18. The computer program product of claim 17, wherein the operations to generate the PRO score using the GPU provision request further comprise:
determining that the GPU provision request is associated with an existing provisioner;
obtaining data associated with the existing provisioner;
executing an assessment check using the data associated with the existing provisioner; and
generating the PRO score using the assessment check.

19. The computer program product of claim 17, wherein the operations to generate the PRO score using the GPU provision request further comprise:
determining that the GPU provision request is not associated with an existing provisioner;
obtaining data associated with a similar provisioner;
executing an assessment check using the data associated with the similar provisioner; and
generating the PRO score using the assessment check.

20. The computer program product of claim 17, wherein the operations to generate the TDA score by analyzing the training data associated with the GPU provision request further comprise:
generating a training data score by analyzing the training data of the GPU provision request using a data threat model;
generating a configuration recommendation based on the GPU provision request, the training data, and service level agreement requirements and training requirements associated with the GPU provision request;
generating a configuration score by comparing a requested configuration from the GPU provision request and the configuration recommendation; and
generating the TDA score using the training data score and the configuration score.

21. The computer program product of claim 20, wherein the data threat model is a toxicity detection model, a personally identifiable information detection model, a derogatory speech detection model, a bias and fairness detection model, a sensitivity detection model, a content appropriateness detection model, or a security threat detection model.

22. The computer program product of claim 17, wherein the operations to generate the intent score using the PRO score, the TDA score, and the domain data associated with the GPU provision request further comprise:
generating a domain data score using an internet protocol (IP) address of the GPU provision request and a history of previous IP addresses associated with a provisioner of the GPU provision request; and
generating the intent score using the domain data score, the PRO score, and the TDA score.

23. The computer program product of claim 17, wherein the operations to monitor the resource as the AI model is built further comprise:
validating authentication of a provisioner of the GPU provision request during execution of a task on the resource; and
in response to an authentication failure of the provisioner of the GPU provision request, terminating the task on the resource of the GPU provision request and adding details of the task to a datastore.

24. The computer program product of claim 17, wherein the operations further comprise, in response to determining that the intent score is below the threshold value, denying access to the resource of the GPU provision request.
